(19) United States
(12) Patent Application Publication
(10) Pub. No.: US 2010/0246041 A1
(43) Pub. Date: Sep. 30, 2010

(54) Natural Lighting System With Sequential Scanning Process

(76) Inventor: Seung-Han Kim, Seongnam-si (KR)

Correspondence Address: REINHART BOERNER VAN DEUREN P.C., 2215 PERRYGREEN WAY, ROCKFORD, IL, 61107, US

(21) Appl. No.: 12/744,653

(22) PCT Filed: Nov. 12, 2008
(86) PCT No.: PCT/KR08/06655

§ 371 Date: May 25, 2010

(30) Foreign Application Priority Data
Nov. 29, 2007 (KR) 10-2007-0123013

(51) Int. Cl. G02B 7/182

(52) U.S. Cl. 359/877

(57) ABSTRACT

A natural lighting system tracks natural light or sunlight, effectively draws the light, distributes the light to necessary places, and sequentially scans the light on the scanning area. The natural lighting system collects the sunlight and then reflects the collected sunlight to a target scanning area based on a sequential scanning mode, and includes at least one reflector disposed according to an optimum control angle for collecting the sunlight, and a sequential scanning drive continuously adjusting the reflector so as to allow the sunlight transferred from the reflector to be sequentially scanned on the target scanning area.

### TECHNICAL FIELD

The present invention relates to a natural lighting system, and more particularly, to a natural lighting system based on a sequential scanning mode, which tracks natural light or sunlight, effectively draws the light, distributes the light to necessary locations, and sequentially scans the light on a scanning area.

### BACKGROUND ART

A natural lighting system for coping with sunshine blocking of low stories and their surroundings of high-rise buildings including apartment houses is disclosed in Korean Patent No. 10-0729721 (titled Natural Lighting System, and granted on Jun. 12, 2007). In the disclosed document, the natural lighting system includes a lighting unit and magnification reflecting means such that sunlight can be cast to a target scanning area on the basis of a position and/or a time. Among them, the lighting unit includes at least one reflector module for collecting the sunlight on a magnification reflecting unit.

The natural lighting system of the document employs a technique that collects the sunlight to intactly scan it on the target scanning area. According to this technique, the sunlight is magnified through the magnification reflecting means, and then is transferred to the target scanning area. However, the size of the magnified area is restricted because the light which a human being feels has to maintain proper sensitivity. As such, it is necessary to arrange the natural lighting system so as to correspond to the size of the target scanning area.

For example, FIG. 1 illustrates the arrangement, particularly the basic arrangement, of the natural lighting system disclosed in Korean Patent No. 10-0729721. The natural lighting system shown in FIG. 1 has the arrangement for receiving the light from the sun 100 and then transferring the light to the shaded area of a rear building 101. It can be seen from FIG. 1 that a plurality of natural lighting systems 200 is arranged along the upper edge of a front building 102 in a row.

This natural lighting system requires a large number in proportion to the size of the target scanning area. Thus, the present invention suggests a method capable of installing a smaller number of natural lighting systems in order to more efficiently operate the natural lighting systems.

### DISCLOSURE OF INVENTION

### Technical Problem

An embodiment of the present invention provides a natural lighting system which allows light to be scanned on a wider target scanning area even on a small scale.

Further, another embodiment of the present invention provides a natural lighting system, which utilizes a positive afterimage effect to transfer light in a sequential scanning mode, thereby keeping sensible brightness approximate to brightness of natural light.

### Technical Solution

According to an aspect of the present invention, there is provided a natural lighting system which collects sunlight and then reflects the collected sunlight to a target scanning area. The natural lighting system is based on a sequential scanning mode, and includes at least one reflector disposed according to an optimum control angle for collecting the sunlight, and a sequential scanning drive continuously adjusting the reflector so as to allow the sunlight transferred from the reflector to be sequentially scanned on the target scanning area.

In an embodiment of the present invention, the light transferred from the reflector may give rise to a positive afterimage attributable to the sequential scanning of the target scanning area.

In another embodiment of the present invention, the reflector may be coupled to a reflector support so as to be pivotable in one direction, and be pivotably coupled with the sequential scanning drive on one side of a lower portion thereof so as to be continuously pivoted around a portion coupled with the reflector support by operation of the sequential scanning drive.

In another embodiment of the present invention, the sequential scanning drive may include a motor fixed to the reflector support, and a crank arm connected to the motor and one side of the lower portion of the reflector.

In another embodiment of the present invention, the sequential scanning drive may include a piezoelectric element fixed to the reflector support and displaced in a vertical direction, and a coupling arm coupled to an upper end of the piezoelectric element and the lower portion of the reflector.

In another embodiment of the present invention, the sequential scanning drive may include a pair of piezoelectric elements displaced in a horizontal direction and fixed to the reflector support disposed at a lower portion of the reflector so as to face each other, and a support arm disposed between the pair of piezoelectric elements in a vertical direction and connected to a center of the lower portion of the reflector. The sequential scanning drive may apply voltage to the piezoelectric elements to cause resonance of a structure configured of the support arm and the reflector such that the reflector is pivoted.

In another embodiment of the present invention, the sequential scanning drive may include a support arm disposed on a reflector support at a lower portion of the reflector in a vertical direction and connected to a center of the lower portion of the reflector in a shape of a band, and a pair of piezoelectric films attached on opposite sides of the support arm. The sequential scanning drive may apply voltage to the piezoelectric films to cause resonance of a structure configured of the support arm and the reflector such that the reflector is pivoted.

In another embodiment of the present invention, the natural lighting system may further include a sequential scanning angle adjustor connected to a lower portion of a reflector support supporting the reflector, wherein sequential scanning angle adjustor allows the reflector and the sequential scanning drive to be rotated at a predetermined angle with respect to a base on which the reflector and the sequential scanning drive are installed.

In another embodiment of the present invention, the natural lighting system may further include a magnification reflecting means, which receives the light from the reflector, transfers the received light to the target scanning area, and magnifies the light from the reflector on the target scanning area in a longitudinal direction.

In another embodiment of the present invention, the reflector may be formed so as to have a shape of a one-axis convex mirror such that the light is magnified on the target scanning area in a longitudinal direction.

In another embodiment of the present invention, the reflector support and the reflector may be connected to a positioning means for adjusting an angle of the reflector so as to be able to sequentially scan the light on a desired target scanning area.

In another embodiment of the present invention, the reflector may include one selected from a square shape, a rectangular shape, and a circular shape.

### ADVANTAGEOUS EFFECTS

According to embodiments of the present invention, the natural lighting system sequentially scans the light reflected to the target scanning area by the reflector, thereby enabling a person to feel the reflected light as continuous light through positive afterimage reaction. Further, the natural lighting system can greatly reduce an installed number as compared to an existing natural lighting system, and remarkably reduce spatial restrictions associated with installation. In addition, the natural lighting system establishes a comparatively simpler system as compared to a conventional natural lighting system, and thus can promote convenience of use and fabrication.

### BRIEF DESCRIPTION OF DRAWINGS

FIG. 1 illustrates arrangement of a conventional natural lighting system;

FIG. 2 illustrates an example where a natural lighting system (NLS) based on a sequential scanning mode according to an embodiment of the present invention is installed;

FIG. 3 illustrates a detailed configuration of the reverse NLS of FIG. 2;

FIG. 4 illustrates an example in which light from a reflector is sequentially scanned in an NLS according to an embodiment of the present invention;

FIG. 5 is a side view illustrating an example to which an NLS having magnification reflecting means is applied;

FIG. 6 illustrates the configuration of an NLS having magnification reflecting means;

FIG. 7 illustrates the arrangement relation between a magnification reflecting means and a base of an NLS;

FIG. 8 illustrates an example in which a magnification reflecting means having a width smaller than that of a base is installed;

FIG. 9 illustrates an example in which a magnification reflecting means having the same width as a base is installed;

FIG. 10 illustrates an example in which a magnification reflecting means having a width greater than that of a base is installed;

FIG. 11 illustrates a sequential scanning drive using a crank arm;

FIG. 12 illustrates a sequential scanning drive using a piezoelectric element;

FIG. 13 illustrates a sequential scanning drive using a pair of piezoelectric elements;

FIG. 14 illustrates a sequential scanning drive using a pair of piezoelectric films;

FIG. 15 illustrates a left/right sequential scanning area AA of three reflector pixels;

FIG. 16 is a schematic side view illustrating a need for angle adjustment when a sequential scanning mode is used;

FIG. 17 is a schematic front view illustrating a need for angle adjustment when a sequential scanning mode is used; and

FIG. 18 illustrates a sequential scanning angle adjustor.

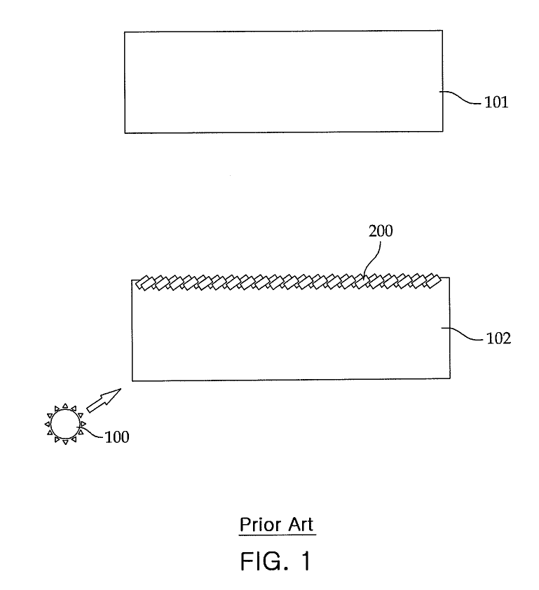

### MAJOR REFERENCE NUMERALS AND SYMBOLS OF THE DRAWINGS

10: reflector 20: sequential scanning drive
30: reflector support 50: positioning means

### MODE FOR THE INVENTION

Reference will now be made in detail to exemplary embodiments of the invention with reference to the accompanying drawings.

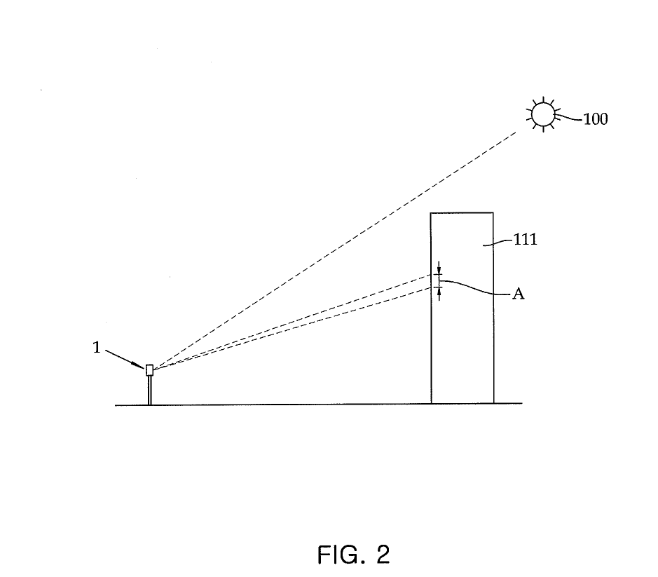

FIG. 2 illustrates an example where a natural lighting system (NLS) based on a sequential scanning mode according to an embodiment of the present invention is installed. It can be seen from FIG. 2 that the NLS is arranged so as to transmit light to a building 111, a shaded area of which is generated by the sun 100. Here, the natural lighting system 1 can be called a reverse natural lighting system. In detail, the reverse NLS employs a method of directly reflecting sunlight to transmit it to a desired scanning area.

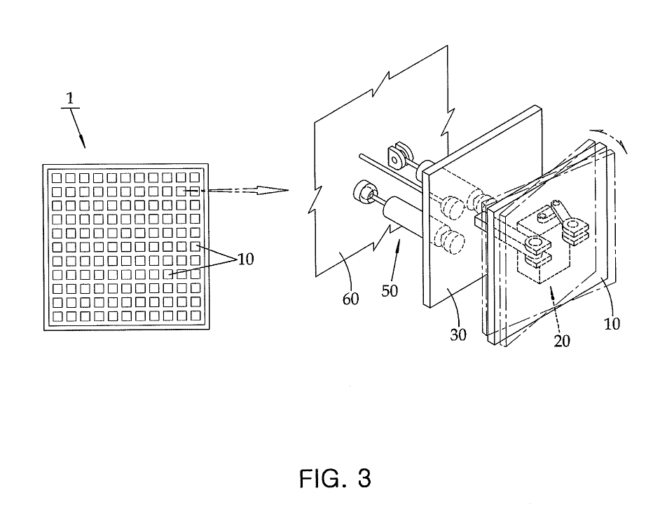

FIG. 3 illustrates a detailed configuration of the reverse NLS of FIG. 2. According to an embodiment of the present invention, the NLS includes a reflector 10 that collects and reflects sunlight, and a sequential scanning drive 20 that continuously adjusts the reflector so as to allow the reflected light to be sequentially scanned within a target scanning area.

Positive Afterimage Effect

According to an embodiment of the present invention, the NLS is characterized by use of a visual positive afterimage effect caused by light sequentially scanned onto a target scanning area A (FIG. 2) at a predetermined frequency. An afterimage or ghost image refers to a phenomenon in which a visual organ (a cone cell) continues to be stimulated after the stimulus of light is removed, and thus visual action remains for a moment. A movie or television is based on a positive afterimage. Due to the positive afterimage, anyone recognizes the light to be continuous without interruption. According to an embodiment of the present invention, the NLS can remarkably reduce an installation scale using this positive afterimage effect, as compared to an existing NLS.

In the reverse NLS as illustrated in FIG. 3, the sequential scanning drive 20 is coupled to the rear portion of the reflector 10. A detailed configuration of the sequential scanning drive 20 will be described below. The sequential scanning drive 20 drives the reflector so as to make continuous pivoting motion at least 30 times per second in a direction of the arrow of FIG. 3.

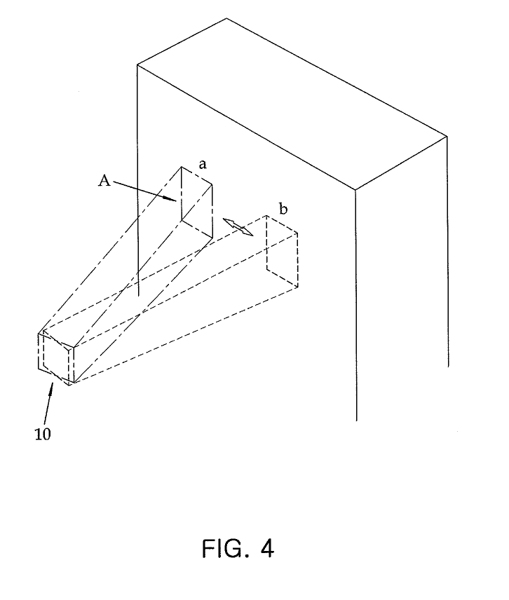

As illustrated in FIG. 4, the light of the target scanning area A is repetitively scanned at least 30 times per second between areas a and b by the continuous pivoting motion of the reflector. This repetitive scanning enables a person who recognizes the light within a visible region of the light to feel existence of continuous light. Here, only when the light is scanned at least 30 times per second, the person can recognize the light to be continuous by means of the positive afterimage effect.

Due to the continuous pivoting motion of the reflector which gives rise to the positive afterimage, the NLS can secure a wider scanning area unlike a conventional NLS. This means that a small number of reflectors (pixels) are required to scan the light on the same area. For example, when the reflector is designed in the shape of a square of 3 cm×3 cm, and is magnified 30 times only in a longitudinal direction, the NLS can be reduced to a scale of one to fifty, as compared to an existing NLS.

Reverse NLS

A detailed configuration of the reverse NLS of FIG. 3 as an embodiment of the present invention is described now.

First, the reflector 10 is configured not only to be continuously pivoted for sequential scanning in the transverse direction of the target scanning area but also have the shape of a one-axis convex mirror for the purpose of magnification and scanning in the longitudinal direction of the target scanning area. In other words, it is preferable that the reflector is configured to have a curvature only in the longitudinal direction for the purpose of the longitudinal magnification. Here, in the case of the transverse direction, since the light is scanned on a predetermined area during sequential reciprocation, separate conditions for transverse magnification are not required. Conversely, the configuration for transverse magnification and transverse sequential scanning is also possible. In addition, the light may be sequentially scanned in the transverse and longitudinal directions at the same time without transverse and longitudinal magnification.

The NLS of this embodiment includes a predetermined number of reflects for each household so as to basically control the lighting over each independent household. Thus, it is most preferable to set the curvature of each reflector so as to be able to magnify the light enough to cover each independent household.

Meanwhile, the reflector 10 is continuously adjusted such that the light can be sequentially scanned on the target scanning area in a transverse direction. To this end, the sequential scanning drive 20 is disposed in the rear of the reflector. The sequential scanning drive continuously adjusts the reflector in a direction of the arrow of FIG. 3, and fixedly supported on a reflector support 30. The reflector support 30 is connected to a positioning means 50 for adjusting an angle of the reflector such that the entire light can be cast from the reflector to a desired target scanning area. The positioning means 50 is for adjusting the target scanning area of the reflector support 30 within a wide range, and is used to freely and independently shift the target scanning area of the reflector.

This positioning means 50 is not limited to a three axial cylinder system as illustrated, but it can use various systems. The positioning means 50 is supported on a base 60. The base 60 includes a plurality of reflectors having this arrangement, which forms one NLS module.

Although not separately illustrated, the NLS may include a separate positioning means for positioning the whole NLS modules according to a position of the sun. The separate positioning means has a function of adjusting an angle of the base 60 such that an incident angle of the sunlight that is incident upon the NLS modules is kept constant, and can employ one of various systems used in an existing NLS.

Sequential Scanning Operation

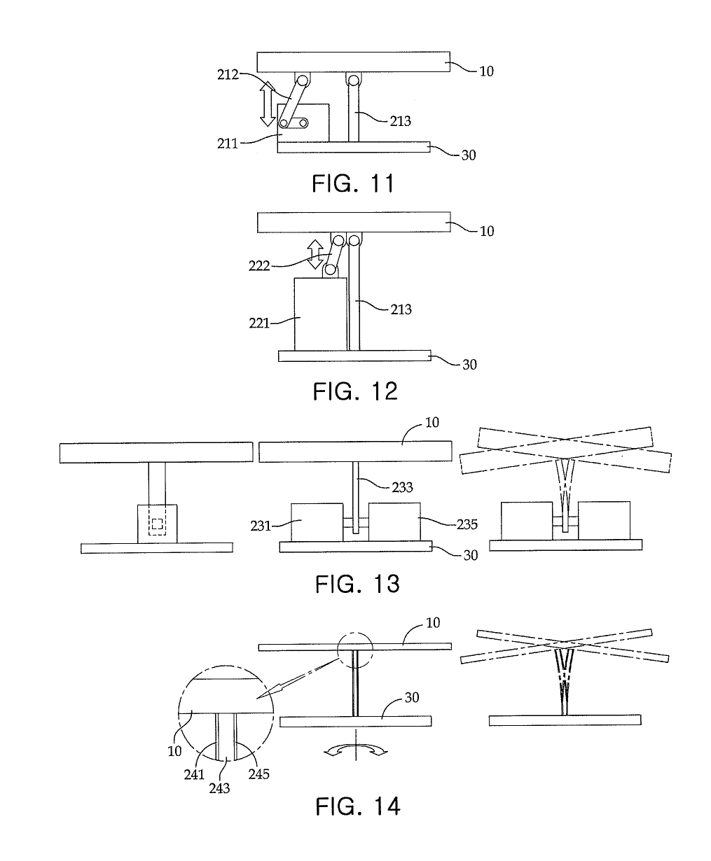

A variety of embodiments of the sequential scanning drive 20 are illustrated in FIGS. 11 through 14. Referring to FIGS. 11 and 12, the reflector 10 and the sequential scanning drive 20 are installed on the reflector support 30. The reflector is coupled to the reflector support 30 so as to be pivotable in one-axial direction. The reflector support 30 is fixedly coupled with a reflector support arm 213 extending to the reflector 10. The reflector 10 is pivotably coupled to an end of the reflector support arm 213, for instance, by a pin.

FIG. 11 shows a driving mode using a crank arm. A motor 211 capable of rotating the crank arm 212 is installed on the reflector support 30. The crank arm 212 is connected to a rear surface of the reflector 10. The motor rotates to drive the crank arm 212, and thereby the crank arm allows the reflector to continuously be pivoted around a pivot point of the reflector support arm 213 at a predetermined angle with respect to a horizontal plane. At this time, the rpm of the motor is controlled, so that the light can be scanned at a frequency that can give rise to the positive afterimage effect on the target scanning area.

FIG. 12 shows a driving mode using a piezoelectric element. As in FIG. 11, the reflector 10 is connected to the reflector support arm 213, and the piezoelectric element 221 is fixed to the reflector support 30. The piezoelectric element 221 is configured to be displaced in a vertical direction when viewed in FIG. 12, and is typically fabricated by stacking a piezoelectric substance to a predetermined height in layers. Thereby, the piezoelectric element 221 can have a predetermined amount of displacement. An upper end of this piezoelectric element is connected with the rear surface of the reflector 10 through a coupling arm 222, so that the reflector 10 is configured to be repetitively pivoted at a predetermined angle. Here, since the piezoelectric element has small vertical displacement, the coupling arm 222 is preferably connected adjacent to the center of the rear surface of the reflector.

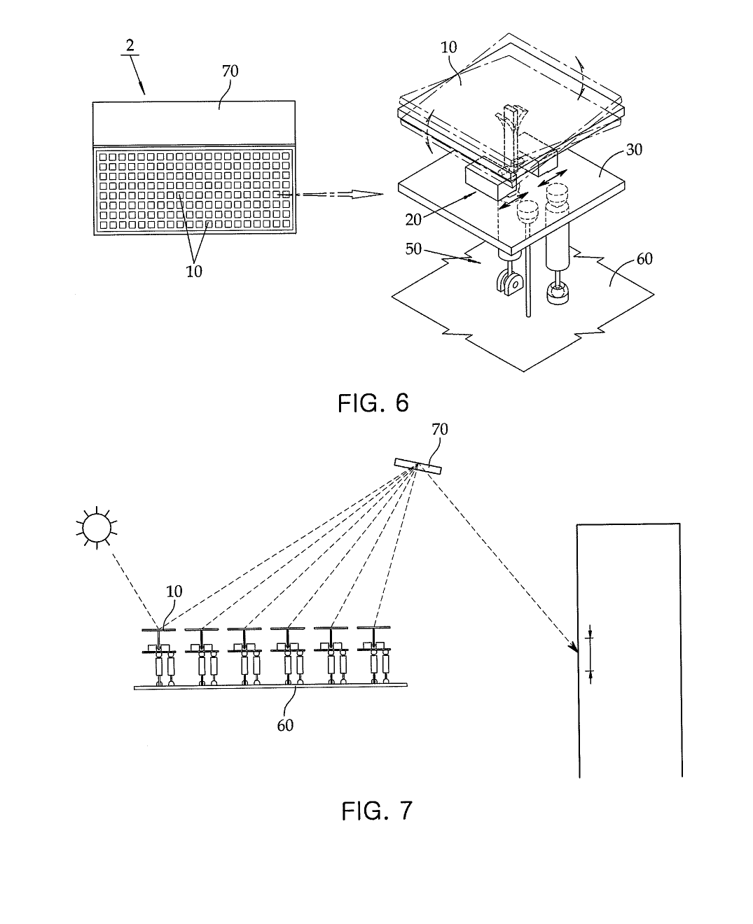

FIGS. 13 and 14 show another driving mode using piezoelectric elements. In FIG. 13, a pair of piezoelectric elements 231 and 235 is arranged on the reflector support 30 so as to be opposite to each other, and then a support arm 233 is fixed between the piezoelectric elements 231 and 235. The support arm 233 has the shape of a band, an upper end of which is connected to the center of the rear surface of the reflector. Thus, the reflector and the support arm 233 are fixed to each other. In this state, the pair of piezoelectric elements is displaced in a horizontal direction. When sine-wave voltages having identical intensity and opposite polarity are applied to the piezoelectric elements arranged so as to be opposite to each other, the piezoelectric elements are displaced together in leftward and rightward directions. At this time, when the voltages are applied to the piezoelectric elements at a resonance frequency of a structure configured of the support arm 223 and the reflector 10, the piezoelectric elements are elastically deformed within an elasticity range in the leftward and rightward directions as illustrated, so that the reflector 10 is also inclined and pivoted in the leftward and rightward directions. When a resonance range is regulated by adjusting the intensity of the voltage applied to each piezoelectric element, the transverse length of the target scanning area of the corresponding reflector can be adjusted. For example, when the resonance frequency of the structure configured of the support arm 223 and the reflector 10 is designed to be 30 Hz or more such that the angle of the reflector is adjusted at least 30 times per second, the pivot angle of the reflector can be sufficiently obtained by small displacement of the piezoelectric elements acting on this frequency, so that the light reflected from the reflector can be sequentially scanned so as to have the positive afterimage effect. The embodiment of FIG. 6 shows an example of applying the embodiment of FIG. 13.

Meanwhile, FIG. 14 shows a driving mode using piezoelectric films 241 and 245. The reflector 10 is supported by a support arm 243. The support arm 243 is fixed between the center of the rear surface of the reflector and the reflector support 30. The support arm is preferably formed of a metal material having the shape of a band. However, as long as a material for the support arm has an elasticity range within which such a material is not permanently deformed by an amount of deformation determined by the piezoelectric films, the material for the support arm is not limited to the metal material. The piezoelectric films 241 and 245 repeating contraction and expansion by means of an intensity of voltage are attached to the opposite surfaces of the support arm 243. The piezoelectric films 241 and 245 are contracted and expanded in a direction perpendicular to the support arm. When one of the piezoelectric films 241 and 245 is expanded, the other is contracted such that the support arm 243 is configured to be bent at a predetermined angle. When this motion is repeated in leftward and rightward directions, the reflector 10 is also inclined in the leftward and rightward directions, and thus performs continuous reciprocation. When sine-wave voltages having identical intensity and opposite polarity are applied to the opposite piezoelectric films, the support arm is greatly displaced within an elasticity range thereof by small deformation of the piezoelectric films. Thus, the reflector is pivoted at a sufficient pivot angle, so that the light reflected from the reflector is sequentially scanned. Further, in a design process, if the resonance cycle of the structure configured of the support arm and the reflector is set to 30 times or more (i.e. resonance frequency of 30 Hz), the light can have the positive afterimage effect.

The sequential scanning drive causing the reflector to be continuously pivoted has been described through the various embodiments of FIGS. 11 through 14. The embodiments of the sequential scanning drive are illustrated as the most exemplary embodiments. However, it will be easily understood by those skilled in the art that the invention is not limited to these embodiments.

NLS Having Magnification Reflecting Means

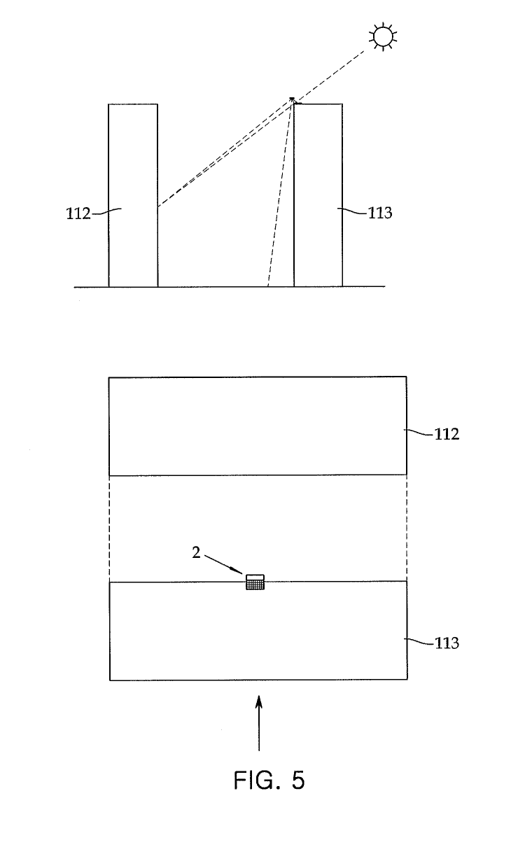

FIG. 5 illustrates an example of applying an NLS 2 having a magnification reflecting means (which will be described below). The NLS of this embodiment differs from the aforementioned reverse NLS in that it includes a magnification reflecting means that collects the light reflected from the reflector and then casts the collected light to the target scanning area. In order to scan the light on a rear building 112, a shaded area of which is generated by a front building 113, the NLS is installed on top of the front building so as to face the rear building. The NLS based on a sequential scanning mode can greatly reduce an installed number as compared to an existing NLS, so that it can configure a very efficient system.

FIGS. 6 and 7 illustrate a configuration of this NLS. Thus, it can be seen from FIGS. 6 and 7 how the magnification reflecting means 70 and the base 60 are basically arranged. The sequential scanning of the reflector 10 and the driving and arrangement of the reflector support 30 are identical to those of the reverse NLS, and so a repeated description thereof will be omitted. However, there is a difference in that the sunlight reflected by the reflector 10 does not directly travel to the target scanning area, but it is collected on the magnification reflecting means 70, is magnified to a predetermined scale by the magnification reflecting means, and is scanned on the target scanning area.

Thus, the reflector 10 has a planar shape unlike that of the reverse NLS, and is moved by the sequential scanning drive 20 so as to be continuously pivoted in a direction of the arrow. The magnification reflecting means 70 magnifies and scans the light reflected by the reflector in a longitudinal direction with respect to the target scanning area. At this time, since the light is repetitively scanned at least 30 times per second on the target scanning area by the continuous pivoting of the reflector in a transverse direction, it will do if the light is not magnified.

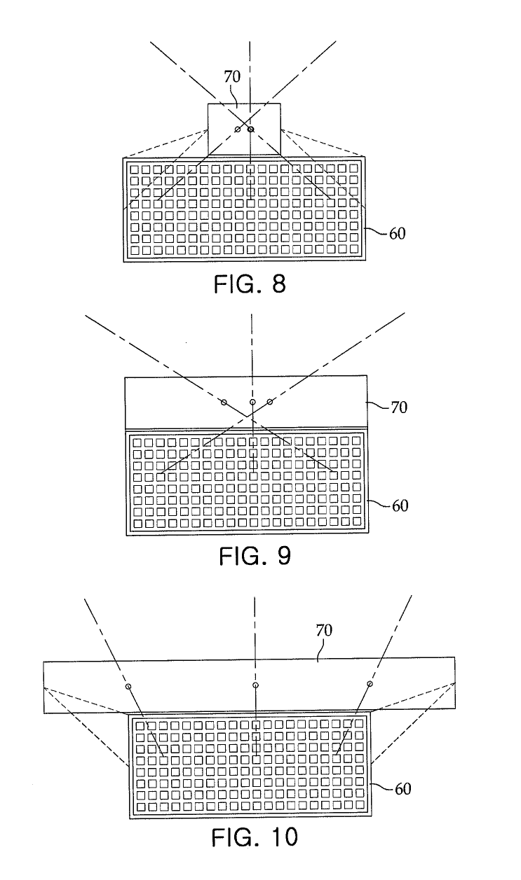

FIGS. 8 through 10 illustrate various examples of installing a magnification reflecting means 70. In FIG. 8, the magnification reflecting means 70 has a smaller width as compared to that of the base 60 on which the reflector is installed. This magnification reflecting means 70 can be used in the typical case in which left-side pixels of the reflector can be arranged so as to relatively take charge of a right side of the entire scanning area. In the case of FIG. 9 or 10, when the entire scanning area has a special shape, such as a pointed shape, other than an ordinary quadrilateral shape, i.e. when the arrangement of the scanning area of each reflector is not fixed, the magnification reflecting means is set so as to be able to be freely used. If the magnification reflecting means 70 is wider than the base 60, the reflector can always scan the light without regardless of the left and right sides of the entire scanning area, so that a degree of freedom of the lighting area is increased.

Adjustment of Angle of Sequential Scanning Area

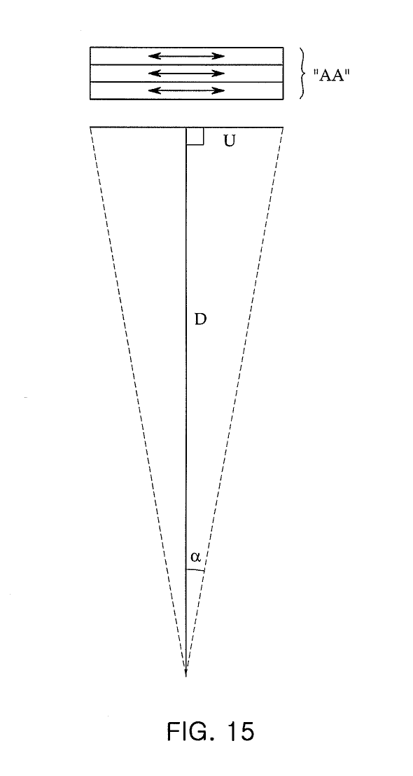

FIG. 15 illustrates a left/right sequential scanning area ‘AA’ of three reflector pixels.

The sequential scanning area can be precisely adjusted according to whether each reflector is turned on or off, a sequential scanning angle and position of each reflector. In the case of the NLS using the magnification reflecting means, when the sequential scanning area is adjusted such that the light of the reflector does not reach the magnification reflecting means, the sequential scanning area can be adjusted either in an Off state or in a mixed state of On and Off states on the target scanning area. The sequential scanning angle ‘α’ is determined by the pivot angle of the reflector caused by the operation of the sequential scanning drive, and can be expressed by the following equation:

α=actan(U/D)

where U is the distance from the center to the edge of an orthogonal projection plane (target scanning area), and D is the distance from the center of the reflector to the center of the scanning area past the magnification reflecting means.

Here, the sequential scanning angle is equal to the pivot angle of the reflector.

For example, providing that the travel distance of the light is 30 meters, and that the width of the target scanning area is 10 meters, U=5, and α=±9.5°. This pivot angle of the reflector can be repeated by driving the sequential scanning drive on the condition of at least 30 times per second, i.e. at least 30 Hz.

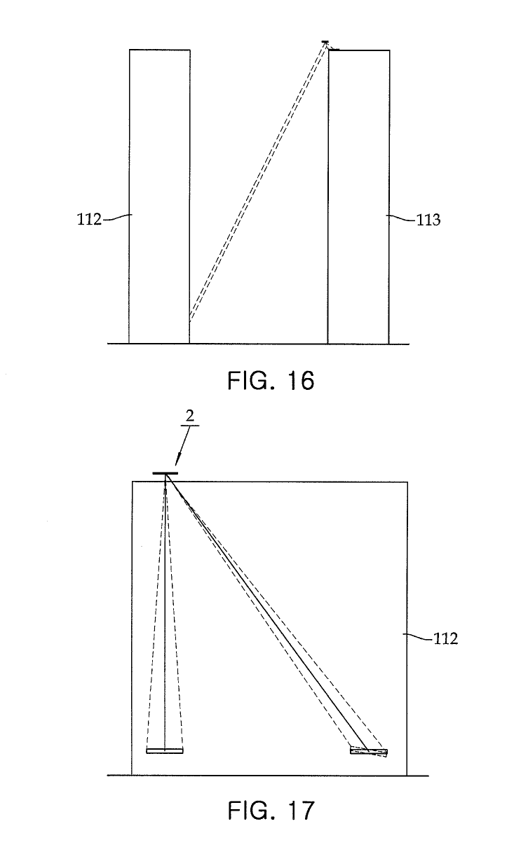

Meanwhile, FIGS. 16 and 17 are schematic views explaining the necessity for adjusting a sequential scanning angle when a sequential scanning mode is used. In FIG. 16, a partial area of a rear building 112 is scanned through the NLS of a front building 113, which is viewed from the side. FIG. 17 is a front view of the structure shown in FIG. 16. In FIG. 17, if the scanning area is disposed in line with the NLS 2 in a vertical direction, the light does not deviate from the scanning area during sequential scanning as shown on the left side of FIG. 17. However, when the scanning area is inclined with respect to the NLS 2, a distance from the NLS to a left-side end of the scanning area is different from a distance from the NLS to a right-side end of the scanning area as shown on the right side of FIG. 17, so that the scanning area does partially deviate from the desired target scanning area.

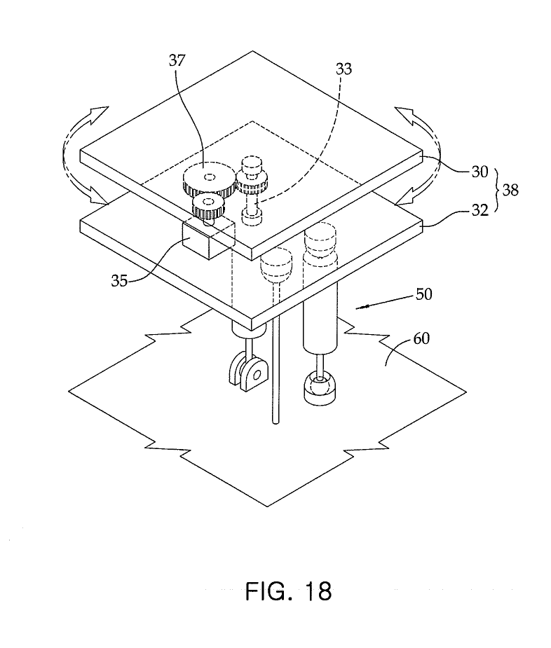

Thus, in order to solve this problem, as in FIG. 18, the NLS is additionally provided with a sequential scanning angle adjustor 38. The sequential scanning angle adjustor 38 is configured so that both of the reflector and the sequential scanning drive continuously pivoting the reflector can be adjusted at a predetermined angle on a plane. To this end, an angle adjusting support 32 is horizontally disposed below the reflector support 30, and is connected with the reflector support 30 by a connecting axle 33 so as to be relatively rotated each other. The connecting axle 33 is provided with a gear, which is connected to a driving gear 35 through a transfer gear 37. By driving the driving gear 35, the reflector support 30 can be rotated relative to the angle adjusting support 32 at a predetermined angle. The angle adjusting support 32 is connected to the base through the positioning means.

This sequential scanning angle adjustor 38 can prevent the light from deviating from the target scanning area during sequential scanning, and accurately transmitting the light from the reflector to the target scanning area of any position through the sequential scanning. The sequential scanning angle adjustor 38 of FIG. 18 is merely illustrative. Thus, it can be easily understood by those skilled in the art that any configuration in which the reflector can be rotated on the plane at a predetermined angle so as to be able to correct the deviation of the scanning area during sequential scanning is within the scope of the present invention.

Further, since the sequential scanning angle is mostly adjusted by minutely adjusting the angle of the reflector, a possibility of interfering between the reflectors is extremely low. However, this interference can be prevented by variously varying the shape of the reflector. In detail, each reflector can be configured to have various shapes such as a square shape, a circular shape, and a rectangular shape. Particularly, the circular reflector is preferable since the interference with its surrounding reflector can be prevented during adjusting the sequential scanning angle. In this manner, the shape of the reflector can be adjusted because the scanning area is formed by the sequential scanning, that is because the shape of the scanning area does not dependent on the shape of the reflector.

1. A natural lighting system, which collects sunlight and then reflects the collected sunlight to a target scanning area, the natural lighting system comprising:
at least one reflector disposed according to an optimum control angle for collecting the sunlight; and
a sequential scanning drive continuously adjusting the reflector so as to allow the sunlight transferred from the reflector to be sequentially scanned on the target scanning area.

2. The natural lighting system according to claim 1, wherein the light transferred from the reflector gives rise to a positive afterimage attributable to the sequential scanning of the target scanning area.

3. The natural lighting system according to claim 1, wherein the reflector is coupled to a reflector support so as to be pivotable in one direction, and is pivotably coupled with the sequential scanning drive on one side of a lower portion thereof so as to be continuously pivoted around a portion coupled with the reflector support by operation of the sequential scanning drive.

4. The natural lighting system according to claim 3, wherein the sequential scanning drive includes a motor fixed to the reflector support, and a crank arm connected to the motor and one side of the lower portion of the reflector.

5. The natural lighting system according to claim 3, wherein the sequential scanning drive includes a piezoelectric element fixed to the reflector support and displaced in a vertical direction, and a coupling arm coupled to an upper end of the piezoelectric element and the lower portion of the reflector.

6. The natural lighting system according to claim 1, wherein
the sequential scanning drive includes a pair of piezoelectric elements displaced in a horizontal direction and fixed to the reflector support disposed at a lower portion of the reflector so as to face each other, and a support arm disposed between the pair of piezoelectric elements in a vertical direction and connected to a center of the lower portion of the reflector, and
the sequential scanning drive applies voltage to the piezoelectric elements to cause resonance of a structure configured of the support arm and the reflector such that the reflector is pivoted.

7. The natural lighting system according to claim 1, wherein
the sequential scanning drive includes a support arm disposed on a reflector support at a lower portion of the reflector in a vertical direction and connected to a center of the lower portion of the reflector in a shape of a band, and a pair of piezoelectric films attached on opposite sides of the support arm, and
the sequential scanning drive applies voltage to the piezoelectric films to cause resonance of a structure configured of the support arm and the reflector such that the reflector is pivoted.

8. The natural lighting system according to claim 1, further comprising a sequential scanning angle adjustor connected to a lower portion of a reflector support supporting the reflector, wherein the sequential scanning angle adjustor allows the reflector and the sequential scanning drive to be rotated at a predetermined angle with respect to a base on which the reflector and the sequential scanning drive are installed.

9. The natural lighting system according to claim 1, further comprising a magnification reflecting means, which receives the light from the reflector, transfers the received light to the target scanning area, and magnifies the light from the reflector on the target scanning area in a longitudinal direction.

10. The natural lighting system according to claim 1, wherein the reflector is formed so as to have a shape of a one-axis convex mirror such that the light is magnified on the target scanning area in a longitudinal direction.

11. (canceled)

12. The natural lighting system according to claim 1, wherein the reflector includes one selected from a square shape, a rectangular shape, and a circular shape.

13. The natural lighting system according to claim 3, wherein the reflector support and the reflector are connected to a positioning means for adjusting an angle of the reflector support so as to be able to sequentially scan the light on a desired target scanning area.

14. The natural lighting system according to claim 4, wherein the reflector support and the reflector are connected to a positioning means for adjusting an angle of the reflector support so as to be able to sequentially scan the light on a desired target scanning area.

15. The natural lighting system according to claim 5, wherein the reflector support and the reflector are connected to a positioning means for adjusting an angle of the reflector support so as to be able to sequentially scan the light on a desired target scanning area.

16. The natural lighting system according to claim 6, wherein the reflector support and the reflector are connected to a positioning means for adjusting an angle of the reflector support so as to be able to sequentially scan the light on a desired target scanning area.

17. The natural lighting system according to claim 7, wherein the reflector support and the reflector are connected to a positioning means for adjusting an angle of the reflector support so as to be able to sequentially scan the light on a desired target scanning area.
